(19) United States
(12) Patent Application Publication
(10) Pub. No.: US 2012/0081408 A1
(43) Pub. Date: Apr. 5, 2012

(54) Mini-Color Image Projector

(75) Inventor: Kuo-Ching CHIANG, Linkou Township (TW)

(73) Assignee: Kuo-Ching Chiang, Linkou Township (TW)

(21) Appl. No.: 12/987,118

(22) Filed: Jan. 9, 2011

(30) Foreign Application Priority Data
Oct. 5, 2010 (TW) 099133924
Nov. 30, 2010 (TW) 099141526

(51) Int. Cl. G09G 5/10; G03B 21/14

(52) U.S. Cl. 345/690; 353/31

(57) ABSTRACT

The present invention includes a light color controller, multiple mono-light sources are coupled to the light color controller to control the emission of the light sources. A display is located in accordance with the multiple mono-light sources to display a gray scale image. Three images with red, green and blue color are generated while the three color lights penetrate through the display, successively. A lens is located to responsive the three color images to project them on a screen.

### CROSS-REFERENCE TO RELATED APPLICATION

This present application claims priority to TAIWAN Patent Application Serial Number 099133924 and 099141526, filed on Oct. 5, 2010 and Nov. 30, 2010 respectively, which are herein incorporated by reference.

### TECHNICAL FIELD

The present invention generally relates to a mini projector, and especially to an image projector with multiple light sources and single display.

### DESCRIPTION OF THE RELATED ART

In pace with the development of information and computer technology, electronic products grow rapidly in trend of small size, multifunction and high operation rate. Based on the incoming era of high technology, telecommunication network and internet becomes a rising industry currently. Following by progress of mobile phone integration technology, communication systems have also been introduced to provide users to obtain information more conveniently. Thus, the communication technology turns to be an important role in the industry, and the communication device business flourishes rapidly due to the essential requirements of communication and the convenience of fetching information. Therefore, Internet, cellular, and PDAs (personal digital assistant) have flooded in the daily life. The internet and communication providers also supply various business services to assist clients to transmit or receive information for extending the market and the coverage of services. And the electronic components tend to become small size, multifunction, and high speed. The communication services providers or the information services providers also have to provide diverse, comprehensive and updated information to the clients. Current portable communication devices commonly used include mobile phones, stock display devices, and PDAs, and these are gradually popular in ordinary life and become indispensable electronic products. Additionally, systems for integrating aforementioned electronic devices also become popular in daily life.

Most projectors presently used employ single light source and multiple LCDs, and images can be magnified through projection lens. But, this structure needs beam splitters and reflector mirrors to split light beams, which is too complicated and can not be minified. In another aspect, DMD chip is also used in the DLP system, however, the cost will be raised and a color wheel is required, and mechanical vibration will occur more easily. In the other aspect, the color separation circuit is also employed in other type of prior art, and nevertheless, it has to separate one color image to three images with different color objects and provides the color object with the same color light, followed by synthesizing those different colors objects subsequently. Thus, the projection means are not only too complicated, but also the color separation circuit is required.

One example of prior art is shown in FIG. 7. In the figure, light emitted from the light source 700 is guided to the LCOS (Liquid crystal on Silicon) 720 through the polarization beam splitter 710. After light passing through liquid crystals, it will be reflected back through the polarization beam splitter 710, and will be projected sequentially by the lens 730. Because almost 50% of polarized light is filter out by the polarization beam splitter 710 and the residual light intensity and the energy are partially absorbed or consumed by the LCOS, such that the luminosity will be insufficient. Further, the optical path is too long.

Recent projector is quite bulky, heavy, and not easy to be taken alone, and it also generates heat with high temperature and efficiency of the conventional projector is low, thus, the typical projector has lots of shortcomings. Referred to FIG. 8, which exhibits optical path in the traditional projector, a white light source 22 is introduced, and light emitted form the white light source 22 can pass through the lens kit 24. Two colors of light can be filtered by light filter 30 and then reflected by the reflection lens 38 into the prism, and rest colors of light can be guided into the prism through the optical devices 34 and 36, and finally, colors of light will be guided into the prism through three colors display elements 28 to be combined, and the combined image will be projected through the projection lens 26 sequentially. Additionally, aforementioned projector requires the relay lens 40 to 42. The optical system of the projector disclosed above utilizes three filters to separate white light into red, green, and blue light, and the RGB images can be combined in the prism after passing through the displays. Since the complicated optical system comprises lots of filters, and reflectors, etc, the size of the projector cannot be minified.

### SUMMARY

Based on aforementioned description, the purpose of the present invention is to provide an image projector with plural light sources and single display.

An image projector with plural light sources and single display includes: a sequent color-light control unit; a plurality of single-color light sources coupled to the color-light control unit for emitting light of the plurality of single-color light sources sequentially; a display correspondingly configured at the plurality of single-color light sources for rendering images, whereby forming red, green, blue images by illuminating the plurality of single-color light sources on the display sequentially; and a projection lens correspondingly configured at the display for projecting the red, green, and blue images sequentially, wherein the order of the aforementioned red, green, and blue images can be altered.

Aforementioned single-color light sources include laser, LED, or organic electro-luminescence elements.

Aforementioned display includes LCD, PDP (plasma display panel), organic light-emitting display, or field emission display.

Aforementioned the plurality of single-color light sources include red, green, blue light sources, or red, green, blue, white light sources.

The image projector can be built in or be connected to a portable device, which includes a cell phone, a notebook, a media player, or a GPS system.

An image projector with transparent substrates comprises: a single-color light source for providing light; a display having two transparent substrates for facilitating light from the single-color light source to pass through, and image forming material is arranged between the substrates for displaying images; a projection lens correspondingly configured at the display with transparent substrates, whereby projecting images formed by light passing through the display with transparent substrates; wherein the prism is not required to combine images in the image projector with transparent substrates. Aforementioned image forming material includes liquid crystal, plasma, or florescence material. Aforementioned display with transparent substrates includes LCD, PDP, organic light-emitting display, or field emission display. The LCD includes color filters.

The single-color light source in the image projector with transparent substrates includes LED, organic light-emitting elements, or field emission elements. The image projector can be built in or be plug-into externally to the portable device, which includes a cell phone, a notebook, a media player, or a GPS system.

A mini-color image projector includes: a light source for providing light; a display with transparent substrates configured at the side of the light source and it has two transparent substrates without color filters for improving light illumination, and the image-forming material is configured between transparent substrates for showing images, wherein the image-forming material comprises florescence material; a Fresnel lens or a collimator configured between the plurality of single-color light sources and the display, such that light emitted from the light sources can become parallel via the Fresnel lens or the collimator, whereby offering the parallel an uniform light beams to pass through the display with transparent substrates; a projection lens correspondingly configured at the display with transparent substrates, whereby projecting images formed by light passing through the display with transparent substrates; wherein the light source is a white light source with RGB image-forming material display, or light sources are red, green, and blue light sources with grey scale image display. The image projector further comprises a color-light control module coupled to the light source if the light source emits RGB light. The light source includes LED, organic light-emitting elements, or field emission elements.

A mini-color image projector includes: light sources for providing light; a LCD configured at side by the light source and having two transparent substrates; a Fresnel lens or a collimator configured between the plurality of single-color light sources and the display, such that light emitted from the light sources can become parallel via the Fresnel lens or the collimator, whereby offering the parallel an uniform light beams to pass through the display with transparent substrates; a projection lens correspondingly configured at the display with transparent substrates, whereby projecting images formed by light passing through the display with transparent substrates; wherein the light source is a white light source with color filters for creating images, or light sources are red, green, and blue light sources with grey scale image display. The image projector further comprises a color-light control module coupled to the light source if the light source emits RGB light, respectively. The image projector can be built in or plug-in externally to a portable device, which includes a cell phone, a notebook, a media player, or a GPS.

A mini-color image projector includes: a planar light source for providing parallel light directly, whereby omitting the Fresnel lens or a collimator so as to compact and minimize the mini-color image projector; a display configured adjacent to the planar light source; a projection lens correspondingly configured at the display, whereby projecting the images on the display by light passing through the display; wherein the light source is a white light source with color image display, or light sources are red, green, and blue light sources with grey scale image display. The image projector further comprises a color-light control module coupled to the light sources if the light sources may emit RGB light. The light source includes organic light-emitting elements, or field emission elements. The image projector can be built in or connected externally to a portable device, which includes a cell phone, a notebook, a media player, or a GPS.

In addition to aforementioned configurations, the present invention further provides a mini-color image projector, which includes: a self-luminous display having two substrates with florescence material for generating images, whereby facilitating to decrease thickness of the projector; a focus lens configured at the side of the self-luminous display such that light emitted from the self-luminous display can pass through the focus lens and focuses at a focal point; a projection lens correspondingly configured at the side of the self-luminous display and positioned at the focal point of the focus lens, whereby projecting the images through the projection lens; wherein the self-luminous display renders color images or grey level images. The focus lens comprises a Fresnel lens or a collimator to minimize the image projector. The image projector may further comprises a light source at another side of the self-luminous display, and if the self-luminous display displays color images, the light source emits single-color white light to offer sufficient illumination; if the self-luminous display is a grey scale image display, the light source comprises at least red, green, and blue light illuminations. The image projector further comprises a color-light control module coupled to the light source for facilitating to emit RGB light sequentially. The self-luminous display includes organic light-emitting display, PDP, electroluminescence display, or field emission display.

A mini-color image projector includes: a self-luminous planar light source having two substrates with florescence material for illuminating, whereby providing parallel light beam and to reduce the thickness of the projector; a display configured at the side of the self-luminous planar light source; a focus lens configured at the side of the display such that light emitted from the self-luminous light source can pass through the display and the focus lens and focus at a focal point; a projection lens correspondingly configured at the adjacent to the self-luminous display and positioned at the focal point of the focus lens, whereby projecting the images through the projection lens; wherein the display displays color images or grey scale images. The focus lens comprises a Fresnel lens or a collimator to minimize the image projector. If the display displays the color images, the self-luminous planar light source emits mono-white light; if the display displays grey scale images, the self-luminous planar light source emits at least red, green, and blue mono-light. The image projector further comprises a color-light control module coupled to the self-luminous planar light source for emitting RGB light serially in an order. The self-luminous planar light source includes organic light-emitting elements, electroluminescence elements. The display includes organic light-emitting display, LCD, PDP, electroluminescence display, or field emission display.

A mini-color image projector includes: a luminescence source for providing light and reducing thickness and energy consumption, whereby facilitating to minimize the image projector; a display configured at side by the luminescence source and having two transparent substrates; a collimation light conversion element configured between the luminescence source and the display, such that light emitted from the luminescence source becomes parallel via the collimation light conversion element, whereby generating parallel and uniform light beams to pass through the display; a projection lens correspondingly configured at the display, whereby projecting images after light passing through the display; if the luminescence source emits white light, the display is a color image display; if the luminescence source emits RGB light, the display renders grey scale image display; wherein the collimation light conversion element includes a Fresnel lens or a collimator. The mini-color image projector further comprises a color-light control module coupled to the light source for illuminating the red, green and blue light beams sequentially, whereby forming color images by visual persistence phenomena. The luminescence source includes organic light-emitting elements, electroluminescence elements, LED or field emission elements. The display includes organic light-emitting display, LCD, PDP, electroluminescence display, or field emission display.

### BRIEF DESCRIPTION OF THE DRAWINGS

FIG. 1 shows a functional diagram of the projector of the present invention.

FIG. 2 illustrates a functional diagram of the projector coupled to a portable device.

FIG. 3 exhibits a functional diagram of the projector of the present invention.

FIG. 4 shows the display of the present invention.

FIG. 5 shows the display of the present invention.

FIG. 6 illustrates an embodiment of the present invention.

FIG. 6A illustrates an embodiment of the present invention.

FIG. 6B illustrates an embodiment of the present invention.

FIG. 6C illustrates an embodiment of the present invention.

FIG. 6D illustrates an embodiment of the present invention.

FIG. 7 shows the prior art.

FIG. 8 shows the prior art.

FIGS. 9 and 9A show the prior arts.

### DETAILED DESCRIPTION

For making readers further understand aforementioned and other purposes, features, and advantages, some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

The present invention can also be built in or plug-in externally to a portable communication device which includes a cellular, a PDA, note book, tablet, or a smart phone. A portable wireless communication device generally includes a cellular, a PDA, or the like. The system of aforementioned wireless communication device generally comprises a wireless communication module, which is compatible with protocol of bidirectional transmission, and the cellular and the PDA comprises at least one bidirectional communication module. In regard to the bidirectional communication module, the adapted protocol is, for instance, GSM, CDMA, PHS, or the communication protocols of bidirectional communication device. Messages provided by service suppliers can be received by the bidirectional communication module, and can be decoded by a decoder, whereby being converted to recognizable signals. The wireless communication device comprises a microprocessor or a CPU, and a user interface coupled to the microprocessor for facilitating input of commands. The commands can be input by touch or voice control. Signals received by bidirectional communication module can be output by the microprocessor and stored in the data or program of the memory unit for being processed, such as checking communication protocol, reading or determining the signals.

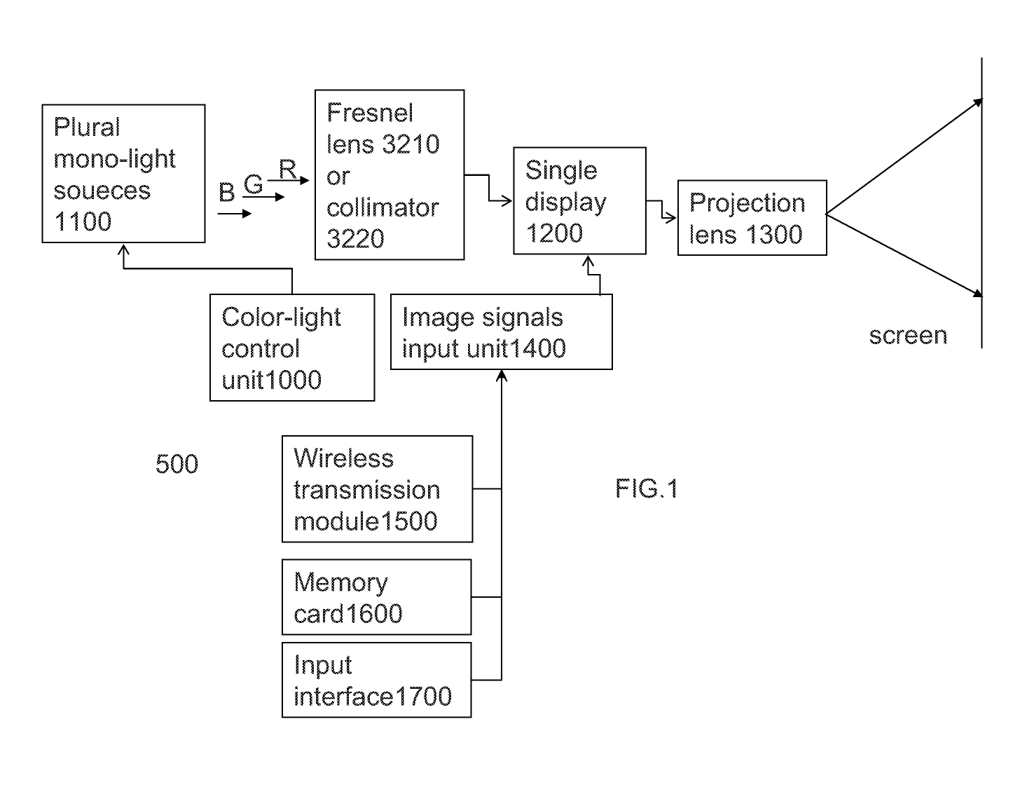

FIG. 1 illustrates the image projector with plural light sources and single display, which comprises a color-light control unit 1000. In an embodiment, a single display 1200 is provided for displaying grey scale images. And those images can be magnified and projected on a screen or wall by the projection lens 1300. Aforementioned display 1200 may includes LCD, organic light-emitting display, field emission display, etc. Multiple mono-light sources 1100 emit at least three kinds of mono-light for emitting blue, green, and red light respectively, thereby facilitating to combine the color image. The image in single LCD can appeared as grey scale, and it can be penetrated by the corresponding light, such as red, green, and blue light, which are emitted respectively, and finally, the image penetrated by corresponding light can be magnified and projected by the projection lens 1300. The emitting order of aforementioned three kinds of mono-light can be arranged randomly, such as BGR (blue, green, red), BRG, GRB, GBR, BRG, or BGR, etc. Because three colors are emitted successively, people can see color images due to visual persistence phenomena. Luminous intensity and emitting time of every color from multiple mono-light sources 1100 can be controlled based on the color information by the color-light control unit 1000.

For improving luminous intensity and preventing the dark light issue, the multiple mono-light sources 1100 can further emit white light in addition to aforementioned three colors, so as to enhance luminous intensity. The white light can be inserted in any arrangements of aforementioned three colors. Images generated by the display 1200 are fed by the image signals input unit 1400. Because the present invention emits at least three kinds of mono-light and sequentially projects a red image, a green image, and a blue image to the screen by a grey scale display, the color separation device is not required and the image has not to be split, therefore, the light beam splitter is not required any more. If LED, laser, or EL (electroluminescence) elements, etc is chosen, the device can be not only minimized, but also achieve heat dissipation efficiency higher than the bulb.

Simply speaking, emitting order and luminous intensity of each independent mono-light can be controlled by the color-light control unit, thereby mixing the three independent images into color image by visual persistence of human eyes based on the three color light beams are emitted in sequence within the duration of the visual persistence. When mono-light passes through the display 1200, the grey scale image on the display 1200 will become mono-color image such as red, green or blue image, and afterward, each mono-color image will be projected by the projection lens 1300, followed by being mixed into a color image due to the visual persistence of human eyes. Hence, the present invention employs plural mono-light sources which generate not much heat.

Further, the present invention introduces a single display. Three images with different colors can be generated in different time because each mono-light emits through the single display in success. Then, those images can be projected on the screen by the projection lens, independently. Therefore, the advantage of the present invention is that a plurality of displays are not required, thereby reducing the cost and simplifying the structure. Furthermore, the light beam splitter for splitting light is not required any more, and the prism for combining split light is not desired either. Consequently, the present invention simplifies the optical structure significantly. Moreover, the color separation device for separating colors of a frame is also not required. In a preferred embodiment, the display 1200 comprises LCD for rendering grey scale images. When grey scale images are employed, the LCD doesn't need any color filter. Because color filters shade light greatly, which make luminosity insufficient, if the color filters can be eliminated, it will be helpful for minimizing the structure, improving luminosity and reducing power consumption.

Aforementioned emitting light source can employ organic light-emitting elements, which emits red, green, and blue light. The projection lens 1300 is configured at the side of the display, and a screen can be placed at a proper position for receiving the projected images. Thus data, files, or games stored in the communication device, the media player, or the computer memory can be magnified and projected to external. Because the present invention utilizes thin and small elements such as organic light-emitting elements, light emission elements, or laser, etc, it can be integrated in the cell phone, digital camera, digital image recorder or GPS. The wireless transmission module 1500 can received images from external, and the images or signals desired to be projected can be input by the image signal input unit 1400. Images or signals desired to be projected can also be input through a memory card or a flash drive 1600, such that inconvenience raised by carrying the computer can be alleviated. Those images or signals can also be input through the input interface 1700, such as the cell phone with USB, or HDMI, thereby projecting images or information in the cell phone.

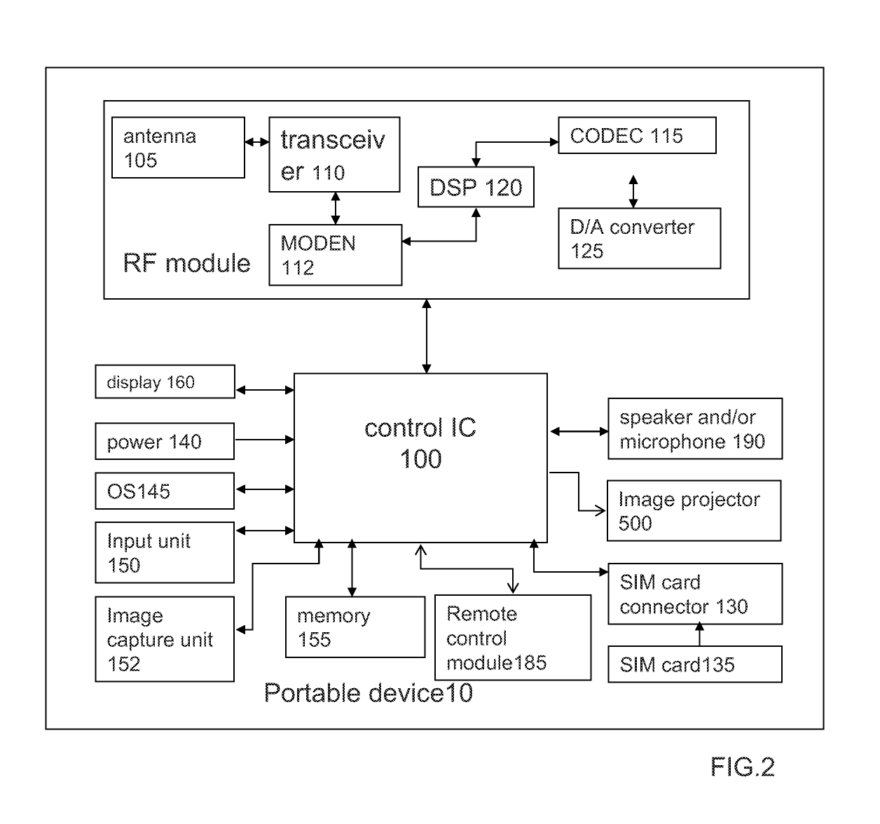

FIG. 2 shows a block diagram of the present invention integrated in a cell phone, which comprises a SIM card connector 130 to carry the SIM card 135, it is well know in the art, the SIM card is not necessary for some other type of cellular such as PHS system. The portable communication device 10 includes a RF module. The RF module includes antenna 105. This antenna 105 is connected to a transceiver 110, which is used to receive and transmit signal. The RF module further includes CODEC 115, DSP 120 and A/D converter as well. The present invention includes a central control IC 100 for controlling process of signals, data, power and input or output. An input unit 150, a built-in display 160, OS 145, and power 140 are coupled to the control IC 100 respectively. The present invention further comprises memory 155 coupled to the control IC 100 for storing data and OS. The memory 155 may include ROM, RAM and nonvolatile FLASH memory, etc, depending on different properties. The RF module may perform the function of signal transmitting and receiving, frequency synthesizing, and digital signal processing. The SIM card hardware interface is used for receiving a SIM card. Finally, the signal is send to the final actuators such as a speaker and a microphone 190. Memory unit can be divided to three parts, which include MASK ROM, nonvolatile memory such as FLASH and SRAM. Generally speaking, fixed data can be stored in MASK ROM, and the system operation software or fixed application program can be generally stored in nonvolatile memory and execute other commands, the nonvolatile memory can still remain data inside when it's out of power, and can be read and wrote repeatedly when power is available. The image capture unit 152 is coupled to the control IC 100.

Another feature is that the present invention further includes a remote control module 185 coupled to the control IC 100 for controlling locks or the electronic devices by the keys or control codes stored in the memory 155. The remote control technology is well known in the art. For example, the remote control module 185 can transmit control signals via IR (infrared ray), internet, or telecommunication network. The control codes, or keys can be downloaded from the service supplier through the communication module of the cell phone, and can be stored in the memory 155. The communication module of the cell phone can transmit control signals, too. Besides, IR of remote control module 185 can also be applied on data transmission in short range. The originality of the present invention is to integrate various electronic devices for benefiting to take it alone and applying it on various situations, thereby improving the convenience. Further, the present invention can share some elements or devices to be integrated. Therefore, aside from communication, the cell phone of the present invention can further project images, be controlled remotely, and be applied on a conference. The present invention includes one or more modules which is/are all not disclosed in any current portable communication device. It is noted that the present invention can be implanted one or more module depending on demands.

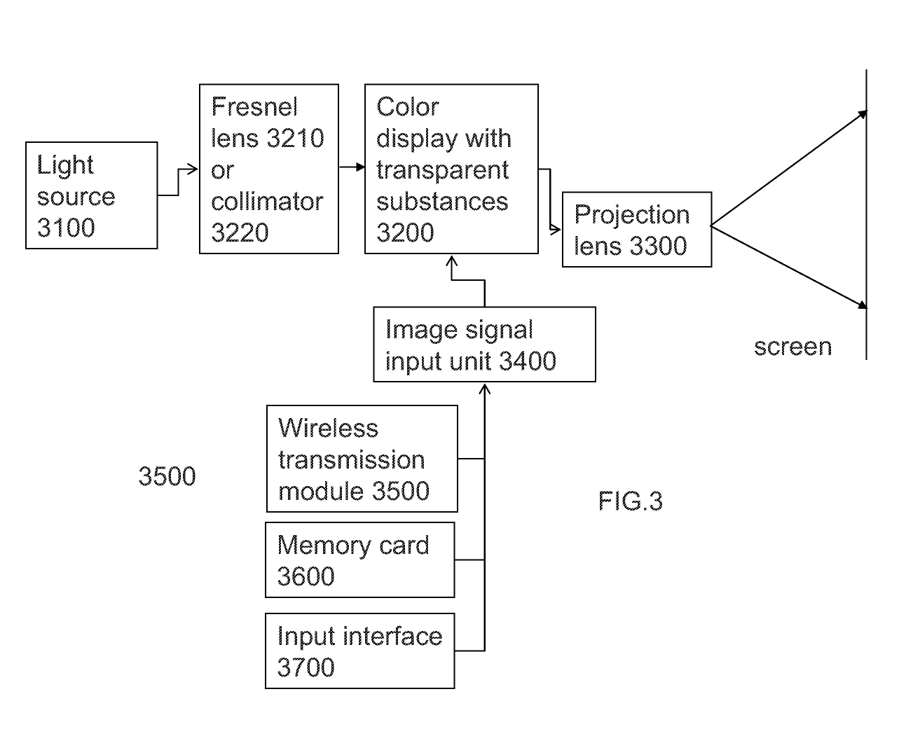

FIG. 3 illustrates the image projector 3500 of the present invention, which comprises a color display with transparent substrates 3200 for rendering color images. The first embodiment displays grey scale images, and is quite different from the present embodiment. The color images can be enlarged and projected on a screen or wall. Aforementioned display 3200 may include LCD, organic light-emitting device, field emission display, etc. The mono-light source 3100 emits white color. The images on the single LCD in the first embodiment is grey scale, followed by being penetrated respectively by three kinds of corresponding mono-light, such as red, green, and blue light. However, the present embodiment is different from the first embodiment. The embodiment employs white light to penetrate the color display, and images will be magnified and projected. Images on the display 3200 are feed by image signal input unit 3400. If Plasma display, field emission display, or organic light emitting display is introduced, florescence powders can be employed to appear grey scale or colors to take place of color filters, thereby raising luminosity.

Therefore, the advantage of the present invention is not requiring a plurality of RGB respective displays, thereby simplifying the circuit structure. Further, the present invention doesn't need a light beam splitter for splitting light from light source, and further doesn't need any prism for combining split light either. Thus, the present invention can simplify the optical structure significantly. Moreover, the color separation device for separating colors of a frame is also not required.

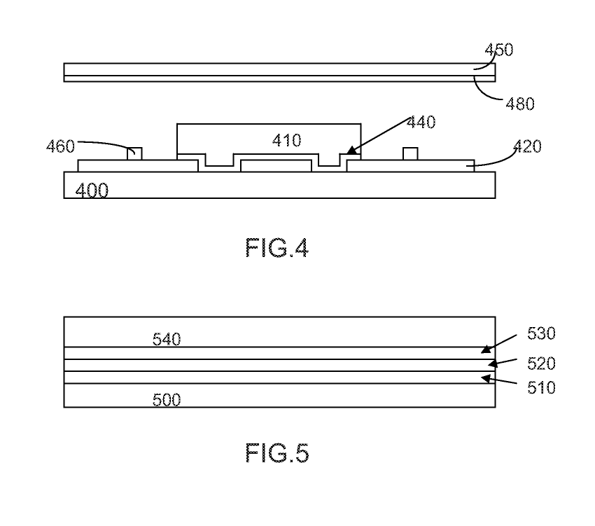

Additionally, the display 3200 in the second embodiment is illustrated in FIG. 4, which shows a cross-section diagram of the field emission display of the present invention. As shown in the figure, a transparent substrate 400 is provided and transparent electrodes 420 are formed on the glass substrate 400 (such as glass, quartz, or acrylate, etc). The transparent electrodes 420 may be made of indium tin oxide (ITO) and may be used as the emitter electrodes. Stacked gate 410 that covers a portion of the transparent electrodes 420 is formed on the glass substrate 400. Emitters 460 that emit electrons are formed on a portion of the transparent electrode 420. Each stacked gate 410 includes a mask layer 440 for covering a portion of the transparent electrodes, and is formed by UV photolithograph mask. The mask layer 440 is preferably transparent to visible light, but opaque to ultra violet rays and can be made of an amorphous silicon layer. The silicon layer will be transparent when the thickness is thin enough.

A stacked gate 410 structure includes first insulating layer/a gate electrode/a second insulating layer/focus gate electrode, sequentially formed over the substrate. The gate insulating layer is preferably a silicon oxide thin film with a thickness of 2 μm or more and the gate electrode is made of chrome with a thickness of about 0.25 μm. The gate electrode is used for extracting an electron beam from the emitter. The focus gate electrode performs as a collector for collecting electrons emitted from emitter so that the electrons can reach a fluorescent film 480 disposed above the emitter 460. If the device is used for display, the substrate can be silicon or transparent substrate. Referring to FIG. 4, a front panel 450 is disposed upward and above the stacked gate. A variety of visual images are displayed on the front panel 450. A fluorescent film 480 is attached to a bottom surface of the front panel 450 that faces the stacked gate and a direct current voltage is applied to the fluorescent film 480 to emit color for display. The fluorescent substance may emit color light by mixing the emitted light if the thin film comprises R, G, B fluorescent substances.

Preferably, the present invention includes three such emission displays that separately display image in red components, green components, and blue component (namely, red, green and blue images). The fluorescent substances emit red, green, and blue visible light when excited by the electron beam, and the light can be evenly distributed on the fluorescent film 480. Spacer separating the front panel 450 from the stacked gate is a black matrix layer and is not shown for convenience. Since the thin film display is formed with thinner thickness and the power consumption is lower than LCD, the present invention may provide a smaller size, lighter weight device. The life of battery may last longer. The field emission device does not require complicated, power-consuming back lights and filters which are necessary for LCD.

Moreover, the device does not require large arrays of thin film transistors, and thus, a major light source of high cost and yield problems for active matrix LCDs is eliminated. The resolution of the display can be improved by using a focus grid to collimate electrons drawn from the microtips. Preferably, the emitter includes a carbon nanotube emitter to further reducing the device size. Further, the display may omit the liquid crystal material. Furthermore, the field emission display does not require the S/D regions which are required by TFT for LCD. In another embodiment, LED source may irradiate mono color light. Namely, blue light, red light and green light LEDs are employed to act the light source. In one case, the LED may be formed in a matrix or linear configuration. Please be noted that the elements with fluorescent substances shown in FIG. 4 (carbon nanotube field emission element) and the electroluminescent panel in FIG. 5 (EL) can be used as light source as well. Similarly, the light source unit can be formed by three mono-light FED (or EL) or a single FED (EL) which may emit three mono-lights. The organic light-emitting element can also be introduced, which doesn't require color filters so that the thickness can be reduced, and doesn't generate too much heat so as to minimize the device.

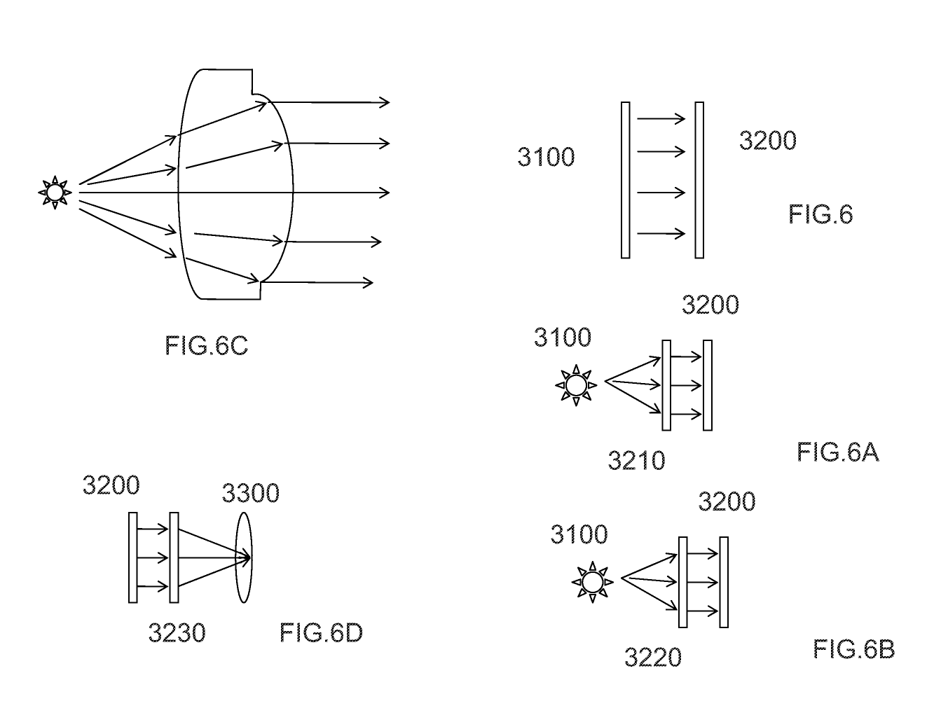

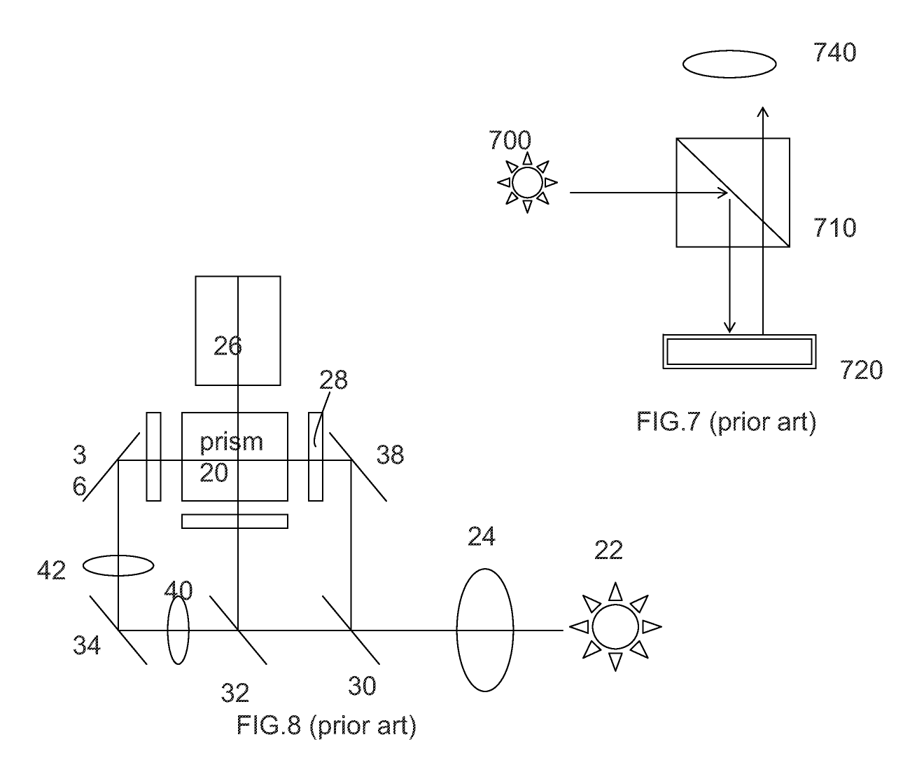

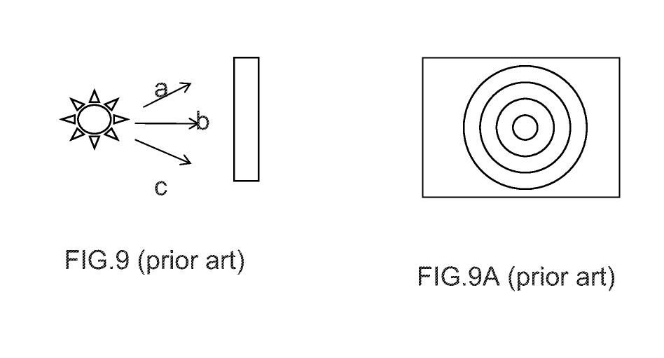

One advantage of the present invention is not requiring any color filter for generating colors, thereby reducing size. But, if the thickness is not concerned, LCD collocated with color filters can also be employed for generating color images. The advantage of the embodiment in FIG. 3 is to eliminate the color filters. In the prior art, please refer to FIGS. 9 and 9A, if the light is point light source, the illumination intensities of the optical path a, b and c are different. The intensity on the display of the optical path a is lower than the one of the optical path b due to the distance from the light source is longer than the one of the light path b. Therefore, the intensity distributed on the display is not uniform and the distribution gradient constructs several circles on the display as shown in FIG. 9A. If the light source 3100 is a planar mono-light source (such as field emitter, organic light emitting element, etc), parallel light can be provided to the display 3200, thereby alleviating non-uniformity of light, as shown in FIG. 6. Other components in the figure are similar with FIG. 1 and FIG. 3, so they are not described redundantly here. Concerning about minimizing, because color filters will shade light considerably, the grey scale image display collocated with three independent light sources are preferred for sequentially generating red, green, blue images, followed by generating color images by the visual persistence of the human eyes. In another embodiment, color filters is not introduced herein and images can be rendered by florescence material, so that simplifying the structure and decreasing opacity, and thus, a mono-light source can be merely required, so as to generating light penetrating through the color display directly. Choices of aforementioned elements can be determined based on cost, resolution, or luminosity, etc.

Referred to FIG. 6 A, if aforementioned planar light source is not employed, a Fresnel lens 3210 can be configured adjacent to the light source 3100. The light source 3100 is positioned at about the focus point of the Fresnel lens 3210, such that the light from light source can turns parallel through the Fresnel lens 3210. The Fresnel lens includes a curved surface cut to be discontinuous, and the curved surface has identical curvature. The curved surface is cut in tiny range, so it may look like numerous of circles. In other words, the Fresnel lens 3210 contains a plurality of concentric circles (ie, Fresnel zone) for achieving light-concentrating. Contrarily, if the light source is positioned at the focal point, a parallel light bean will be generated and will penetrate the lens. In the meantime, the Frenel lens 3210 can reduce the thickness for minimizing the device. The Fresnel lens can be regarded as a serial of prisms arranged circularly, wherein the edge is sharper, and center is smoother. The configuration of the Fresnel lens allows reducing the thickness, weight, and size of the present invention dramatically. Besides, the Fresnel lens configured in front of the light source can be applied in aforementioned embodiments, such as embodiments of FIG. 1, or FIG. 3, and is not limited to the current embodiment.

A collimator 3220 can also be introduced to replace aforementioned Fresnel lens or to cooperate with the Fresnel lens for facilitating to generate parallel light, such as shown in FIG. 6B. The collimator 3220 comprises a curved lens, and the light source is positioned at the focal point of the curved lens. The surface of the collimator 3220 that faces the light source has higher curvature, and the other surface not facing the light source has lower curvature. The collimator 3220 can also check whether other optical components are located on the optical axis, and hence, it can not only make light parallel, but also be used for correction. The collimator 3220 configured in front of the light source can further be applied in aforementioned embodiments, and is not limited to the present embodiment. Aforementioned Fresnel lens may also be configured between the display and the projection lens, wherein the projection lens is positioned at the focal lens.

In another embodiment, apart from aforementioned features, if the self-luminous color display, such as OLED, field emission display, or EL display, is employed, the light source can be omitted since the florescence layer therein can illuminate when providing current. If the luminosity is in the acceptable range, the light source can be retrenched, thereby further achieving the advantage of minimizing Compared to the LCD, the advantages include: thickness thinner than 1 mm, and lighter weight; solid structure with vibration resistance better than liquid. Moreover, it's advantageous that the structure almost has no issues about the viewing angle, so that the images would still not be distorted while being watched in a widely viewing angle. For, example, AMOLED (Active Matrix/Organic Light Emitting Diode) can be employed, because it submits higher speed, higher contrast ratio, wider viewing angle, and doesn't require any back light plate, it can be manufactured in a thinner configuration and can save more power. The AMOLED without the back light plate can save about 30-40% of the cost of the back light module in TFT LCD, referred to FIG. 6D. A Fresnel lens or collimator 3230 is configured between the projection lens 3300 and the self-luminous display 3200, and aforementioned projection lens is positioned at the focal point of the Fresnel lens or the collimator 3230.

A reflector can be configured at the backside of the light source in each embodiment mentioned above depending on demands, so as to reflect light to the display.

Aforementioned collimators can be replaced by the light grating, so as to provide uniform light.

Aforementioned units and modules can be combined arbitrarily according to demands. As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A color image projector including:
a color-light control unit;
a plurality of mono-light sources coupled to said color-light control unit for emitting light of said plurality of mono-light sources in sequence;
a gray scale display correspondingly configured to said plurality of mono-light sources for displaying gray scale image, and whereby forming red, green, blue images in sequence by said plurality of single-color light sources; and
a projection lens correspondingly configured to said display for projecting said red, green, and blue images sequentially, whereby forming color images by visible persistence.

2. The color image projector according to claim 1, wherein said red, green, blue images is arranged randomly.

3. The color image projector according to claim 1, wherein said plurality of mono-light sources comprise laser, LED, or organic electro-luminescence device.

4. The color image projector according to claim 1, wherein said gray scale display includes LCD, PDP (plasma display panel), organic light-emitting display, electroluminance display, or field emission display.

5. The color image projector according to claim 1, wherein said plurality of mono-light sources comprise red, green, blue light sources, or red, green, blue, white light sources.

6. The color image projector according to claim 5, wherein said image projector is built in or plug-in externally to a portable device, and said portable device includes a cell phone, a notebook, a media player, digital camera, digital recorder or a GPS.

7. The color image projector according to claim 1, further comprising a Fresnel lens or a collimator configured between said plurality of mono-light sources and said gray scale display.

8. A color image projector including:
a self-luminous display having two substrates with florescence material for generating images, whereby facilitating to decrease a thickness;
a focus lens configured adjacent to of said self-luminous display such that light emitted from said self-luminous display passes through said focus lens and focuses at a focal point; and
a projection lens correspondingly configured at said focal point of said focus lens to project said images through said projection lens;
wherein said self-luminous display displays color images or grey scaleimages.

9. The color image projector according to claim 8, wherein said focus lens includes a Fresnel lens or a collimator to minimize a size of said color image projector.

10. The color image projector according to claim 8, further comprising a light source configured at another side of said self-luminous display, and if said self-luminous display is a color image display, said light source emits mono-white light; if said self-luminous display is a grey scale display, said light source includes at lest red, green, and blue mono-light sources, and a color-light control module coupled to said light source for emitting RGB light sequentially.

11. The color image projector according to claim 10, wherein said self-luminous display includes organic light-emitting display, PDP (plasma display panel), electroluminance display, or field emission display.

12. A color image projector including:
a self-luminous planar light source having two substrates with florescence material for illuminating, whereby providing parallel light beam and decreasing a thickness;
a display configured at a side of said self-luminous planar light source;
a focus lens configured to said display such that light emitted from said self-luminous planar light source passes through said display and said focus lens and focuses at a focal point; and
a projection lens correspondingly configured at said focal point of said focus lens, whereby projecting images through said projection lens;
wherein said display displays color images or grey scale images.

13. The color image projector according to claim 12, wherein said focus lens includes a Fresnel lens or a collimator for facilitating to minimize a size of said color image projector.

14. The color image projector according to claim 13, wherein if said display is a color image display, said self-luminous planar light source emits single-color white light; if said display is a grey scale image display, said self-luminous planar light source emits at least red, green, and blue light; and further comprising a color-light control module coupled to said self-luminous planar light source for emitting RGB light sequentially.

15. The color image projector according to claim 14, wherein said self-luminous planar light source includes organic light-emitting element or field emission element;
wherein said self-luminous display includes organic light-emitting display, PDP (plasma display panel), electroluminance display, or field emission display.

16. A color image projector including:
a planar light source for providing substantially parallel light beams, whereby omitting a Fresnel lens or a collimator adjacent to said planar light source so as to minimize said color image projector;
a display configured at side by said planar light source; and
a projection lens correspondingly configured at said display, whereby projecting images rendered by light passing through said display; if said planar light source emits white light beams, said display being a color image display; if said planar light source emits R, G, B light beams, said display being a grey scale image display.

17. The mini-color image projector according to claim 16, wherein if said planar light sources includes said R, G, B light beams, said color image projector further comprises a color-light control module coupled to said planar light source to emit R, G, B light sequentially, whereby forming color images by visual persistence.

18. The mini-color image projector according to claim 16, wherein said planar light source includes organic light-emitting element, field emission element, or electroluminescence element; wherein said display includes organic light-emitting display, LCD, PDP (plasma display panel), electroluminance display, or field emission display.

19. The color image projector according to claim 16, furthering comprising a collimation light conversion element configured between said projection lens and said display.
